(19) United States
(12) Patent Application Publication
(10) Pub. No.: US 2007/0095800 A1
(43) Pub. Date: May 3, 2007

(54) SURFACE TREATMENT DEVICE

(75) Inventor: GA-LANE CHEN, Santa Clara, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,389

(22) Filed: Aug. 3, 2006

(30) Foreign Application Priority Data
Oct. 27, 2005 (CN) 200510100769.1

(51) Int. Cl. B23K 26/00

(52) U.S. Cl. 219/121.6

(57) ABSTRACT

A surface treatment device includes a working platform, a laser source, a focus lens, a detector and a controller. The working platform is provided for supporting a workpiece thereon. The laser source is provided for producing laser beams. The focus lens is arranged between the working platform and the focus lens for focusing the laser beams to a spot for treating the workpiece. The detector is provided for detecting information of the spot and generating a feedback signal corresponding to the detected information. The controller is electrically connected with the laser source, the working platform and the detector and configured for receiving the feedback signal from the detector to control emitting of the laser beams of the laser source and movement of the working platform.

### DESCRIPTION

1. Technical Field

The present invention generally relates to surface treatment devices, and more particularly to a device for treating surfaces of molds.

2. Description of the Related Art

With the increasing complexity and precision required in the manufacture of mold structures, current mold machining technologies are facing difficulties in meeting demand. Traditional mechanical machining methods and electrical discharge machining methods may not meet surface roughness requirements of modern precision molds.

A typical vibrating ultrasonic mold polishing apparatus is used to polish surfaces of a mold. The polishing apparatus includes an ultrasonic vibrator, an ultrasonic horn for amplifying vibrations, and a flexible element mounted on the ultrasonic horn for contacting with a surface of the mold to be polished. In the polishing process, a grinding material is positioned on the surface of the mold to be polished, and the flexible element is vibrated by amplified vibrations, thus creating friction between the mold surface to be polished and the grinding material. Thus, the surface of the mold is polished by the flexible element through the grinding material.

The typical polishing apparatus can be controlled to vibrate, and to achieve multi-angle polishing. However, the flexible element directly contacts with the surface to be polished in the polishing process. Therefore, the structure or size of the flexible element may directly affect the quality of polishing. In addition, it is very difficult to achieve satisfied polishing precision when the apparatus is used to polish a mold having fine and anomalous structures such as holes, grooves etc.

Therefore, it is desired to provide an improved apparatus that overcomes the above-described problems.

### SUMMARY OF THE INVENTION

A surface treatment device includes a working platform, a laser source, a focus lens, a detector and a controller. The working platform is provided for supporting a workpiece thereon. The laser source is provided for producing laser beams. The focus lens is arranged at an appropriate position, i.e., between the working platform and the focus lens, for focusing the laser beams to a spot for treating the workpiece. The detector is provided for detecting information of the spot and generating a feedback signal corresponding to the detected information. The controller is electrically connected with the laser source, the working platform and the detector and configured for receiving the feedback signal from the detector to control emitting of the laser beams of the laser source and movement of the working platform.

Advantages and novel features will become more apparent from the following detailed description when taken in conjunction with the accompanying drawing.

### BRIEF DESCRIPTION OF THE DRAWINGS

Many aspects of the present surface treatment device can be better understood with reference to the following drawing. The components in the drawing are not necessarily drawn to scale, the emphasis instead being placed upon clearly illustrating the principles of the present surface treatment device. Moreover, in the drawing, like reference numerals designate corresponding parts throughout the view.

FIG. 1 is a schematic view of a surface treatment device, in accordance with a preferred embodiment.

### DETAILED DESCRIPTION OF THE INVENTION

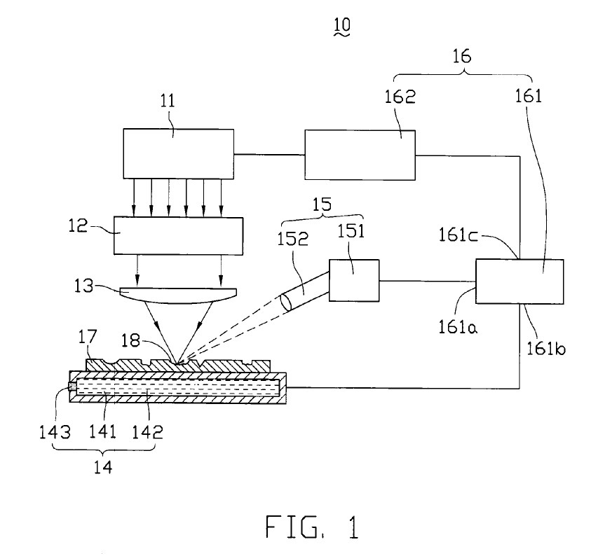

A mold machining apparatus for performing surface treatment, welding, cutting and other mold manufacturing processes is provided. Referring to FIG. 1, a surface treatment device 10 for treating surfaces of a mold is shown. The surface treatment device 10 includes a laser source 11, a focus lens 13, a working platform 14, a detector 15 and a controller 16. The laser source 11 is provided for emitting laser beams. The focus lens 13 is used to focus the laser beams from the laser source 11 to a spot for treating a workpiece to be machined. In order to advantageously focus the laser beams, a blocking shutter 12 is additionally provided. The blocking shutter 12 is positioned between the laser source 11 and the focus lens 13 for guiding laser beams to reach the focus lens 13. The working platform 14 is provided to support the workpiece to be machined, such as a mold 17 to be machined, and is positioned at an appropriate place what the focused laser beams can treat the mold 17. The detector 15 has a feedback end 151 and a detecting end 152. The feedback end 151 is electrically connected with the controller 16, and the detecting end 152 detects information of a treated spot of the laser beams on the mold 17. The controller 16 is connected with the laser source 11 and the working platform 14, for respectively controlling the laser source 11 and the working platform 14 after receiving a corresponding feedback signals from the detector 15. The working platform 14 can be controlled to move or rotate in various desired direction. That is, according to the machining requirements, a location of the mold 17 can be controlled via adjust the working platform 14.

The laser source 11 can be a solid-state laser source, and it can emit pulse laser beams. The laser source 11 may be a neodymium ion doped yttrium aluminum garnet (Nd-YAG) laser, a yttrium ion doped yttrium aluminum garnet (Yb-YAG) laser or a neodymium ion doped vanadate (Nd-YVO₄) laser. A wavelength of the Nd-YAG laser is about 1064 nanometers. A wavelength of the Yb-YAG laser is about 940 nanometers. A wavelength of the Nd-Vanadate laser is in a range from about 1047 nanometers to about 1064 nanometers.

The detector 15 detects information of the processing state and feeds back the detected signal corresponding to the detected information to the controller 16. The controller 16 includes a first controlling unit 161 and a second controlling unit 162. The first controlling unit 161 has a first end 161a, a second end 161b and a third end 161 c. The first end 161a, second end 161b and third end 161c of the first controlling unit 161 are respectively electrically connected with the feedback end 151 of the detector 15, the working platform 14 and one end of the second controlling unit 162. The second controlling unit 162 further includes another end which is connected with the laser source 11 for controlling the emitting of the laser beams. Alternatively, the first controlling unit 161 and the second controlling unit 162 may be replaced by one controlling unit, if one controlling unit can respectively control the laser source 11 and the working platform through the detector 15.

The surface treatment process may bring a great quantity of heat, a cooling system is desired to avoid heat distortion of the mold 17. For example, the working platform 14 is a cooling device itself. That is, the working platform 14 defines a cavity 141 with a cooling solution 142 contained therein, and a seal plug 143 engages in an outlet of the cavity 141 for sealing the cooling solution 142. Thus, during the surface treating process, the mold 17 can be continuously cooled by the cooling solution 142. Alternatively, in the surface treatment process, the working platform 14 may be set in a cooling system, for example, in a cooling room.

The present surface treatment device 10 can precisely treating the surface of the mold 17. Firstly, the surface of the mold 17 is treated by a focused light point. A dimension of the light point is very small (i.e. 1 micrometer to 10 micrometers across), thus, it can achieve satisfactory treating precision even if the surface of the mold 17 has fine and anomalous structures such as holes, grooves etc. Secondly, in the treating process, the dimension of the light point, the treating frequency of the laser beams, the desired roughness of the surfaces of the mold 17, or other relative parameters all can be detected by the detector 15, while the detected results are instantly fed back to the controller 16. So, the controller 16 can instantly adjust the treating parameters to meet the process requirements.

A method for surface treating the mold 17 employing the aforesaid surface treatment device 10 is provided. The method includes the following steps: firstly, the mold 17 with a surface 18 to be treated is placed on the working platform 14. Being controlled by the first controlling unit 161 of the controller 16, the working platform 14 can move in any desired direction. The mold 17 can move together with the working platform 14, thus it can be processed in various directions needed. The mold 17 may be comprised of nickel phosphide, stainless steel coated with nickel phosphide, aluminum alloys, magnesium alloys, aluminum-titanium alloys, and other metal or alloys.

Secondly, the laser source 11 is turned on for processing the surface 18 of the mold 17. The laser source 11 is controlled to emit a desired frequency and quantity of the laser beams. The laser beams are adjusted by the blocking shutter 12, and then are focused by the focus lens 13 to form an appropriately sized light point. In the present embodiment, the size of the light point can be adjusted from 1 micrometer to 10 micrometers. Such sized light points can process the surface 18 with high precision.

During the aforementioned treating process, the detector 15 instantly detects the size of the light point, and feeds back the detected result to the controller 16. For example, the surface 18 has a number of regions to be treated, when the present region has been processed, and the processed result meets a determined requirement, a finishing signal generated by the detector 15 is transmitted to the first controlling unit 161. The first controlling unit 161 then controls the working platform 14 to move to a next region to be treated, and a next treating process starts. However, once the processed result does not meet the determined requirement, or the size of the light point does not meet the surface treatment requirement, these failure information detected by the detector 15 are transmitted to the first controlling unit 161. The first controlling unit 161 then transmits the failure information to the second controlling unit 162, for adjusting the laser emitting parameters of the laser source 11. When the present processing result or the size of the light point reaches the determined requirements, the laser source 11 will be controlled to retain the present working state.

The surface treatment device 10 can be used to polish surfaces of molds, or can be used to pattern some predetermined patterns on the mold surfaces. For super polishing or patterning by laser beams, surface roughness parameters, such as average roughness (Ra) and peak roughness (Rp) of the surface 18 of the mold 17 are determined by the following. The average roughness is in a range from about 0.2 nanometers to about 1 nanometer, the peak roughness is in a range from about 0.6 nanometers to about 3 nanometers.

In one example, to reach the above surface roughness parameters, the polishing parameters should fulfill the following conditions: the laser source is Nd-YAG laser, the pulse energy is in a range from about 10 micro-joules to about 30 micro-joules, the pulse duration is in a range from about 1 nano-second to about 5 nano-seconds, the repetition rate is in a range from about 1000 hertz to about 3000 hertz.

In another example, to reach the above surface roughness parameters, the patterning parameters should fulfill the following conditions: the laser source is Nd-YAG laser, the pulse energy is in a range from about 30 micro-joules to about 300 micro-joules, the pulse duration is in a range from about 10 nano-seconds to about 300 nano-seconds, the repetition rate is in a range from about 3000 hertz to about 10000 hertz. Therefore, employing a same laser source, the surface treatment device 10 can perform laser polishing and laser patterning processes, only requiring adjustment of the relative processing parameters. In addition, according to the laser polishing and laser patterning examples, in order to achieve an equal surface roughness degree, the process condition of the laser patterning process is more rigorous than that of the laser polishing process, for a patterned surface having a more finely surface structure.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A surface treatment device comprising:
a working platform for supporting a workpiece thereon;
a laser source configured for emitting laser beams;
a focus lens configured for focusing the laser beams to a spot for treating the workpiece;
a detector configured for detecting information related to the spot and generating a feedback signal corresponding to the detected information; and
a controller electrically connected with the laser source, the working platform and the detector and configured for receiving the feedback signal from the detector to control emitting of the laser beams of the laser source and movement of the working platform.

2. The surface treatment device as claimed in claim 1, wherein the surface treatment device further comprises a blocking shutter positioned between the laser source and the focus lens for guiding the laser beams from the laser source to reach the focus lens.

3. The surface treatment device as claimed in claim 1, wherein the detector has a detecting end and a feedback end, the feedback end is electrically connected with the controller, the detecting end detects information related to the spot of the workpiece to be treated, and the detected information is fed back to the controller through the feedback end.

4. The surface treatment device as claimed in claim 1, wherein the laser source is a solid-state laser source.

5. The surface treatment device as claimed in claim 1, wherein the laser source is a neodymium ion doped yttrium aluminum garnet (Nd-YAG) laser, a yttrium ion doped yttrium aluminum garnet (Yb-YAG) laser or a neodymium ion doped vanadate (Nd-Vanadate) laser.

6. The surface treatment device as claimed in claim 5, wherein a wavelength of the Nd-YAG laser is about 1064 nanometers.

7. The mold surface treatment device as claimed in claim 5, wherein a wavelength of the Yb-YAG laser is about 940 nanometers.

8. The surface treatment device as claimed in claim 5, wherein a wavelength of the Nd-Vanadate laser is in a range from about 1047 nanometers to about 1064 nanometers.

9. The surface treatment device as claimed in claim 1, wherein the laser source is a pulse laser source.

10. The surface treatment device as claimed in claim 9, wherein an pulse energy of the pulse laser source is in a range from about 10 micro-joules to about 30 joule, a pulse duration of the pulse laser source is in a range from about 1 nano-second to about 5 nano-seconds, a pulse repetition is in a range from 1000 hertz to 3000 hertz.

11. The surface treatment device as claimed in claim 9, wherein an pulse energy of the pulse laser source is in a range from about 30 micro-joules to about 300 micro-joules, a pulse duration of the pulse laser source is in a range from about 10 nano-seconds to about 300 nano-seconds, a pulse repetition is in a range from 3000 hertz to 10000 hertz.

12. The surface treatment device as claimed in claim 1, wherein the working platform comprises a container with a cooling solution contained therein.

13. The surface treatment device as claimed in claim 1, wherein the controller comprises a first controlling unit and a second controlling unit, the first controlling unit comprises a first end connecting with the detecting end of the detector, a second end connecting with the working platform, and a third end connecting with one end of the second controlling unit, another end of the second controlling unit is connected with the laser source.

14. The surface treatment device as claimed in claim 1, wherein a size of the spot is in the range from about 1 micrometer to about 10 micrometers.

15. The surface treatment device as claimed in claim 1, wherein the working platform is moveable and rotatable in various desired direction.

16. A method for treating a workpiece comprising the following steps:
providing a working platform to support the workpiece theron;
focusing laser beams emitted from a laser source to a spot at the workpiece to thereby treating a region of the workpiece;
detecting information related to the detected information; and
adjusting emitting of the laser beams of the laser source via a controller receiving the feedback signal.

17. The method as claimed in claim 16, wherein the laser source is a neodymium ion doped yttrium aluminum garnet (Nd-YAG) laser, a yttrium ion doped yttrium aluminum garnet (Yb-YAG) laser or a neodymium ion doped vanadate (Nd-Vanadate) laser.

18. The method as claimed in claim 16, wherein the laser source is a pulse laser source.

19. The method as claimed in claim 18, wherein an pulse energy of the pulse laser source is in a range from about 10 micro-joules to about 30 micro-joules, a pulse duration of the pulse laser source is in a range from about 1 nano-second to about 5 nano-seconds, a pulse repetition is in a range from 1000 hertz to 3000 hertz.

20. The method as claimed in claim 18, wherein an pulse energy of the pulse laser source is in a range from about 30 micro-joules to about 300 micro-joules, a pulse duration of the pulse laser source is in a range from about 10 nano-seconds to about 300 nano-seconds, a pulse repetition is in a range from 3000 hertz to 10000 hertz.
